(19) United States
(12) Patent Application Publication
(10) Pub. No.: US 2014/0349194 A1
(43) Pub. Date: Nov. 27, 2014

(54) SEPARATOR AND METHOD FOR MANUFACTURING THE SEPARATOR

(71) Applicant: TOYOTA BOSHOKU KABUSHIKI KAISHA, Aichi-ken (JP)

(72) Inventor: Yuki KUMABUCHI, Seto-shi (JP)

(73) Assignee: TOYOTA BOSHOKU KABUSHIKI KAISHA, Aichi-ken (JP)

(21) Appl. No.: 14/221,519

(22) Filed: Mar. 21, 2014

(30) Foreign Application Priority Data
May 27, 2013 (JP) 2013-110986

(51) Int. Cl. H01M 2/14; H01M 2/16

(52) U.S. Cl. CPC H01M 2/145; H01M 2/162; H01M 2/1673
USPC 429/254; 264/6

(57) ABSTRACT

A separator arranged between a pair of electrode sheets includes a nonwoven fabric formed of thermoplastic resin fibers spun by a melt-blowing process. The fibers include fine fibers having fiber diameters of 0.1 μm or more and 1 μm or less, and thick fibers having fiber diameters of 8 μm or more and 30 μm or less. The fine fibers and the thick fibers are mixed over the entire thickness of the nonwoven fabric.

### BACKGROUND OF THE INVENTION

The present invention relates to a separator for electrochemical device and a method for manufacturing the separator.

Conventionally, in electrochemical devices such as batteries and capacitors, a sheet-like separator is arranged between a cathode sheet and an anode sheet. Separators formed of a nonwoven fabric are well known as such a separator (for example, refer to Japanese Laid-Open Patent Publication No. 10-172533). The nonwoven fabric used in the separator disclosed in Japanese Laid-Open Patent Publication No. 10-172533 is formed of thermoplastic resin fibers such as polypropylene, and includes, in a mixed state, both fine fibers having fiber diameters of 2 μm to 8 μm and thick fibers having fiber diameters of 9 μm to 15 μm. According to such a separator, the fine fibers ensure electrolyte retentivity and air permeability, and the thick fibers increase the strength of the separator.

The separator disclosed in Japanese Laid-Open Patent Publication No. 10-172533, however, still has room for improvement in increasing battery output when employed as, for example, a separator for lithium-ion secondary battery.

### SUMMARY OF THE INVENTION

The present invention provides a separator that effectively increases the output of an electrochemical device and a method for manufacturing the separator.

In accordance with one aspect of the present invention, a separator arranged between a pair of electrode sheets is provided. The separator includes a nonwoven fabric formed of thermoplastic resin fibers spun by a melt-blowing process. The fibers include fine fibers having fiber diameters of 0.1 μm or more and 1 μm or less and thick fibers having fiber diameters of 8 μm or more and 30 μm or less. The fine fibers and the thick fibers are mixed over the entire thickness of the nonwoven fabric.

In accordance with another aspect of the present invention, a method for manufacturing the above described separator is provided. The method includes:

(a) discharging molten resin from a nozzle in a fibrous form;

(b) extending the fibrous molten resin by blowing hot air diagonally with respect to a discharge direction and from around onto the discharged fibrous molten resin, thereby forming extended resin fibers; and

(c) manufacturing a nonwoven fabric by collecting the extended resin fibers.

In the process (b), hot air forming an air curtain that blocks outside air is further blown circumferentially about the hot air blown onto the fibrous molten resin.

In accordance with another aspect of the present invention, a method for manufacturing the above described separator is provided. The method includes:

(a) discharging molten resin from a nozzle in a fibrous form;

(b) extending the fibrous molten resin by blowing hot air from around onto the discharged fibrous molten resin, thereby forming extended resin fibers; and

(c) manufacturing a nonwoven fabric by collecting the extended resin fibers.

In the process (b), the hot air is discharged through an inclined passage, which is formed to surround the nozzle such that the inclined passage approaches the nozzle toward a discharge direction of the molten resin, and a parallel passage, which extends from a distal end of the inclined passage downward to be parallel with a central axis of the nozzle. The distal end of the nozzle is located downstream of, in the discharge direction of the molten resin, an intersection of lines extended from streamlines of the hot air flowing through the inclined passage.

Other aspects and advantages of the invention will become apparent from the following description, taken in conjunction with the accompanying drawings, illustrating by way of example the principles of the invention.

### BRIEF DESCRIPTION OF THE DRAWINGS

FIG. 1 is an exploded perspective view illustrating a battery including separators according to a first embodiment;

FIG. 2 is a partial cross-sectional view illustrating one of the separator of the first embodiment;

FIG. 3 is a partial plan view illustrating one of the separator of the first embodiment;

FIG. 4 is a schematic diagram of a manufacturing apparatus for manufacturing a nonwoven fabric used in the separator of the first embodiment;

FIG. 5 is a partial cross-sectional view illustrating the spinneret of the manufacturing apparatus of FIG. 4;

FIG. 6 is a partial cross-sectional view mainly illustrating one of the separators in the battery of FIG. 1;

FIG. 7 is a partial cross-sectional view mainly illustrating a separator according to a comparative example; and

FIG. 8 is a schematic diagram illustrating a manufacturing apparatus for manufacturing a nonwoven fabric used in a separator according to a second embodiment.

### DETAILED DESCRIPTION OF THE PREFERRED EMBODIMENTS

### First Embodiment

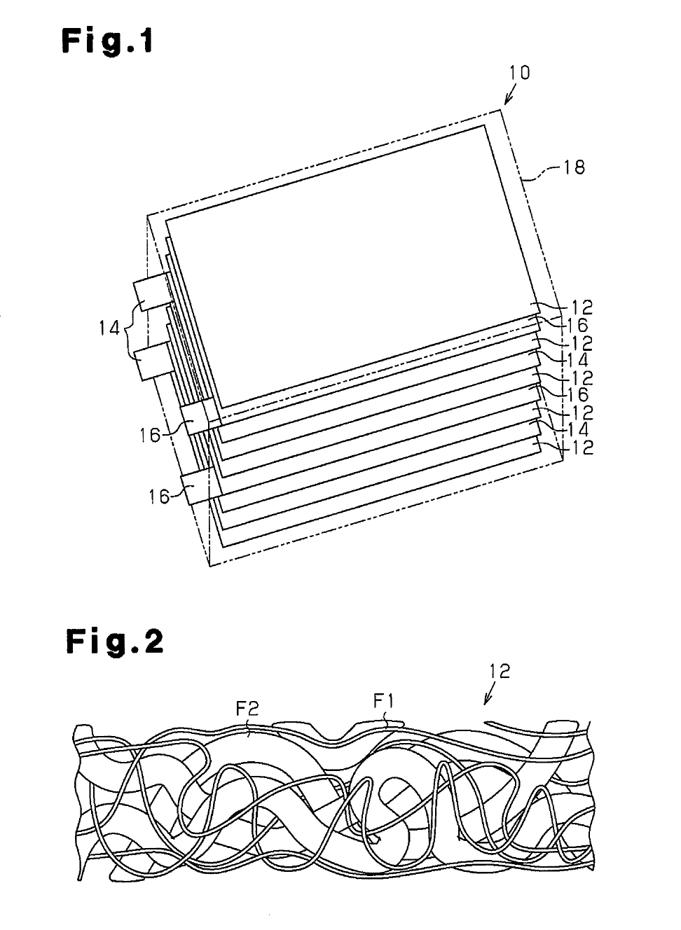

A separator and a method for manufacturing the separator according to a first embodiment will now be described with reference to FIGS. 1 to 7. The separator is used as separators 12 for a lithium-ion secondary battery 10.

As shown in FIG. 1, the lithium-ion secondary battery 10 (hereinafter, simply referred to as the battery 10) includes a laminated body formed by alternately laminating cathode sheets 14 and anode sheets 16 with the separators 12 located therebetween. The laminated body is covered by a metal sheath 18. The separators 12 are impregnated with liquid electrolyte.

The cathode sheets 14 are made of lithium metal oxide. The anode sheets 16 are made of a carbon-based material. The separators 12 are made of a nonwoven fabric. The cathode sheets 14, the anode sheets 16, and the separators 12 are all rectangular. The thickness of the separators 12 is, for example, 15 μm or more and 200 μm or less, and is preferably 15 μm or more and 90 μm or less, and is more preferably 15 μm or more and 50 μm or less.

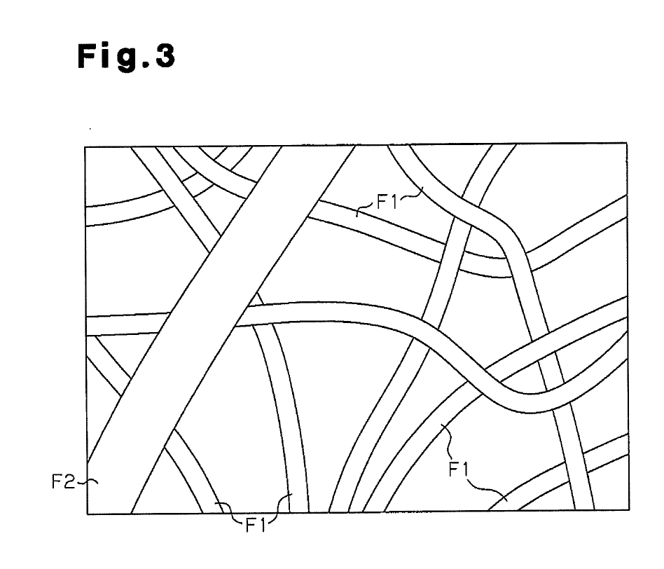

As shown in FIGS. 2 and 3, the nonwoven fabric used in the separator 12 is formed of polypropylene fibers spun by a melt-blowing process. The fibers include fine fibers F1 having fiber diameters of 0.1 μm or more and 1 μm or less and a mean fiber diameter of 0.8 μm, thick fibers F2 having fiber diameters of 8 μm or more and 30 μm or less, and intermediate fibers (not shown) having fiber diameters of more than 1 μm and less than 8 μm. Furthermore, the fine fibers F1, the thick fibers F2, and the intermediate fibers are mixed over the entire thickness of the nonwoven fabric. The fine fibers F1 and the thick fibers F2 may be configured as part of a single thread, or may be formed of separate threads.

FIG. 3 shows only the outline of the fine fibers F1 and the thick fibers F2 extracted from images of a separator taken with a scanning electron microscope. The inventor took scanning electron microscope images of the separator 12 at different positions, and made such extracted images. In the extracted images, the percentage of the number of the fine fibers F1 and that of the thick fibers F2 were calculated. The resulting average percentages of the number of the fine fibers F1 and the number of the thick fibers F2 were approximately 90% and approximately 10%, respectively.

Furthermore, although not shown, the inventor took cross-sectional images of the separator 12 at different positions. The cross-sectional images were used to calculate the average percentages of the total cross-sectional area S1 of the fine fibers F1, the total cross-sectional area S2 of the thick fibers F2, and the total cross-sectional area S3 of the intermediate fibers in the separator 12. The resulting average percentages of S1, S2, and S3 were approximately 8%, approximately 11%, and approximately 81%, respectively.

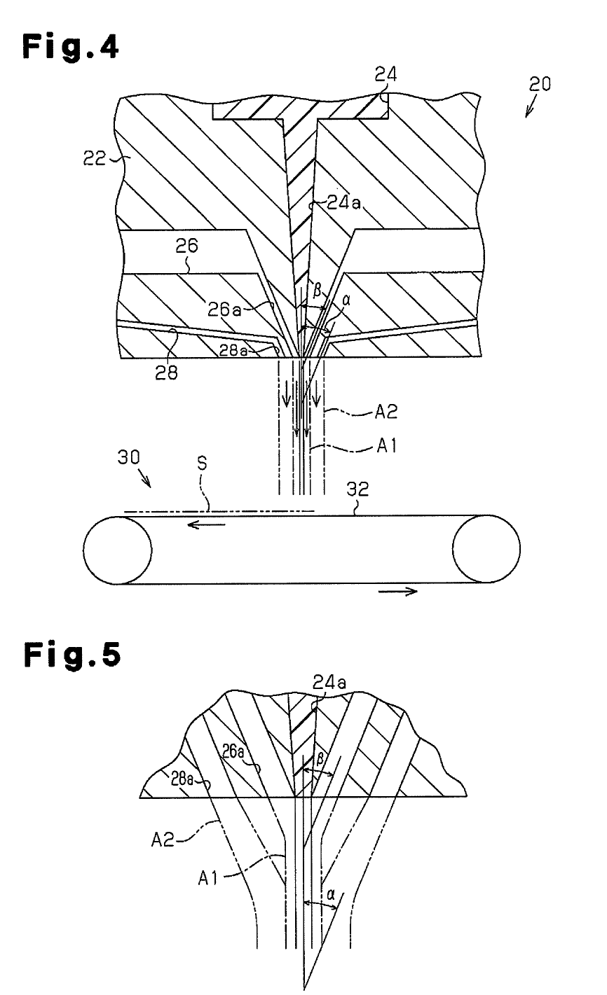

A manufacturing apparatus 20 for manufacturing the nonwoven fabric used in the separators 12 will now be described with reference to FIGS. 4 and 5.

As shown in FIGS. 4 and 5, the manufacturing apparatus 20 manufactures the nonwoven fabric by a melt-blowing process. The manufacturing apparatus 20 includes a spinneret 22, which discharges molten resin that has been extruded from a non-illustrated extruder. Inside the spinneret 22 is formed a resin passage 24 that has a nozzle 24a for discharging the molten resin. The nozzle 24a extends downward in the vertical direction, and tapers toward the lower end.

A first passage 26 is formed around the nozzle 24a. The first passage 26 has an annular outlet port 26a for blowing hot air A1. A second passage 28 is also formed circumferentially about the outlet port 26a. The second passage 28 has an annular outlet port 28a for blowing hot air A2. The outlet port 26a of the first passage 26 and the outlet port 28a of the second passage 28 are inclined to approach the nozzle 24a as they extend downward. The hot air A1 blown out of the outlet port 26a of the first passage 26 is thus blown against a fibrous molten resin discharged from the nozzle 24a. The flow rate of the hot air A1 is set to a speed faster than the discharge speed of the molten resin from the nozzle 24a. Blowing the hot air A1 against the molten resin in this manner extends the molten resin.

The inclination angle α of the outlet port 28a of the second passage 28 with respect to the vertical direction is equal to the inclination angle β of the outlet port 26a of the first passage 26 with respect to the vertical direction. That is, the orientations of the outlet port 28a and the outlet port 26a are parallel with each other. The blowing direction of the hot air A2 blown out from the outlet port 28a of the second passage 28 is thus parallel with the blowing direction of the hot air A1. Since an air curtain is formed circumferentially about the hot air A1 by the hot air A2, the hot air A1 is less likely to be affected by the outside air. This prevents temperature decrease of the hot air A1, and thus prevents temperature decrease of the molten resin. Consequently, the molten resin is kept at a high temperature, and is extended to thin down until the fiber diameter becomes approximately 0.8 μm by the hot air A1. The resin fiber is formed in this manner.

A belt conveyor 30 is provided below the spinneret 22. The extended resin fiber is collected in a sheet form on a belt 32 of the belt conveyor 30, so that a nonwoven fabric S is formed. The thus formed nonwoven fabric S is extended by applying pressure with non-illustrated calender rolls at a position downstream of the belt conveyor 30.

Operation of the separator according to the first embodiment will now be described in comparison with, in particular, a separator 112 of a first comparative example and a separator (not shown) of a second comparative example.

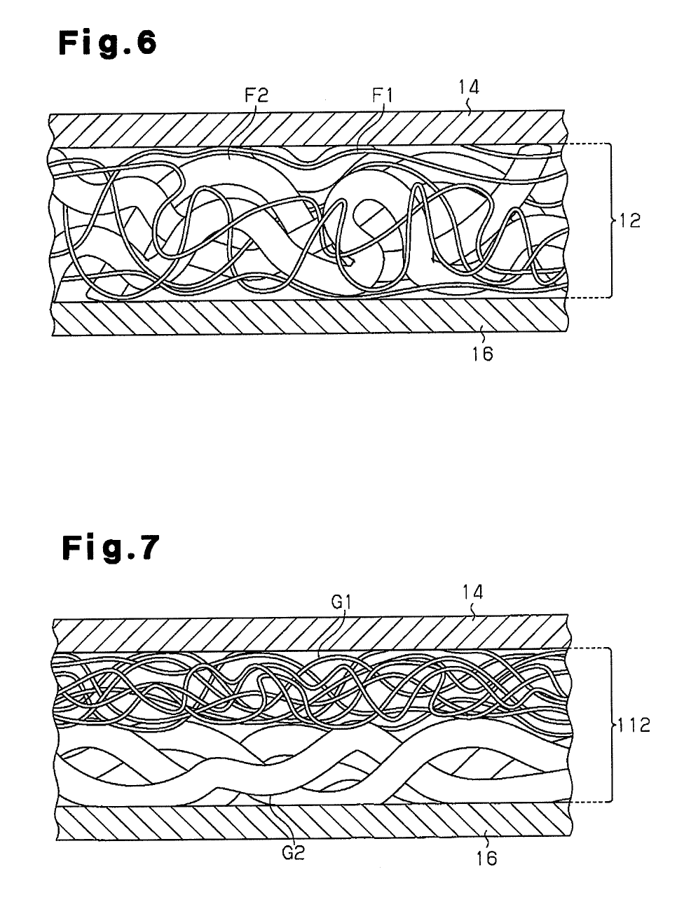

As shown in FIG. 7, the separator 112 of the first comparative example 1 has a two-layer structure including a layer with only fine fibers G1 having a mean fiber diameter of 0.8 μm, and a layer with only thick fibers G2 having a mean fiber diameter of 8 μm. The mass per unit area and the thickness of the separator 112 are the same as the separators 12 of the first embodiment shown in FIG. 6.

The separator of the second comparative example differs from the separators 12 of the first embodiment in that the mean fiber diameter of the fine fibers is 2 μm, and the other structures are identical to the separators 12 of the first embodiment.

As shown in FIG. 6, in the separator 12 of the first embodiment, the fine fibers F1 and the thick fibers F2 are mixed over the entire thickness of the nonwoven fabric, and each of the fibers F1, F2 exists in a wider area as compared to the separator 112 of the first comparative example shown in FIG. 7. This prevents the fibers F1, F2 from being crushed when the nonwoven fabric is extended by applying pressure with the calender rolls. Furthermore, the mean fiber diameter of the fine fibers F1 is 0.8 μm, which is thinner than the minimum value (2 μm) of the fiber diameter that can be spun by the conventional melt-blowing process. Due to this, the area of the fibers F1, F2 that contact the electrode sheets 14, 16 is less than that in the separator 112 of the first comparative example. The smaller the contact area between the electrode sheets 14, 16 and the fibers F1, F2 is, the greater the contact area between the electrode sheets 14, 16 and the electrolyte becomes, which results in efficient utilization of the electrode sheets 14, 16. The separators 12 of the first embodiment thus reduce the electric resistance between the electrode sheets 14, 16, and increase the output of the battery 10.

The direct-current resistance value (measurement value) of the separators 12 of the first embodiment is 10.5Ω, and the direct-current resistance value (measurement value) of the separator 112 of the first comparative example is 11.5Ω. That is, the electric resistance of the separators 12 of the first embodiment is less than the electric resistance of the separator 112 of the first comparative example by approximately 10%. The reason for this is assumed to be, as described above, that the fine fibers F1 and the thick fibers F2 are mixed over the entire thickness of the nonwoven fabric.

Furthermore, the measurement value of the direct-current resistance value of the separator according to the second comparative example is 11.4Ω. That is, the electric resistance of the separators 12 of the first embodiment is less than the electric resistance of the separator of the second comparative example by approximately 10%. The reason for this is assumed to be, as described above, that the fiber diameter of the fine fibers F1 is thinner than that of the second comparative example.

The separator 12 of the first embodiment includes the thick fibers F2 that have fiber diameters of 8 μm or more and 30 μm or less and have higher rigidity than the fine fibers F1. The separator 12 of the first embodiment does not become excessively thin when being pressed against the electrode sheets 14, 16 as compared to a separator including only the fine fibers F1. In addition, the separator 12 includes the fine fibers F1 having a mean fiber diameter of 0.8 μm. In the nonwoven fabric, when the mass per unit area is the same, the thinner the fiber diameter is, the smaller the spaces between the fibers becomes. That is, the spaces between the fibers in the separator 12 of the first embodiment are smaller than the spaces between the fibers having a mean fiber diameter of 2 μm. When a separator that uses fine fibers having a mean fiber diameter of 2 μm is thinned to increase the energy density of the battery, lithium dendrite deposited on an anode sheet may grow through the spaces between the fibers and reach a cathode sheet, thereby causing short-circuits. In order to prevent short-circuits, the separator needs to have a sufficient thickness. In contrast, since the spaces between the fibers are small in the separator 12 of the first embodiment, the lithium dendrite deposited on the anode sheet 16 is prevented from growing through the spaces. The dendrite is thus prevented from contacting the cathode sheet 14 even when the separator 12 is thinned.

The nonwoven fabric used in the separator 12 is formed of resin fibers spun by the melt-blowing process having fiber diameters of 0.1 μm or more. The strength required by the separator 12 is thus satisfied.

Furthermore, the nonwoven fabric used in the separator 12 is formed of resin fibers having fiber diameters of 30 μm or less. This avoids the problem that thinning of the separator 12 is hindered by the fiber diameter of the resin fiber.

The separator of the first embodiment described above has the following advantages.

(1) The nonwoven fabric used in the separator 12 is formed of polypropylene fibers spun by the melt-blowing process. The nonwoven fabric includes the fine fibers F1 having fiber diameters of 0.1 μm or more and 1 μm or less, and the thick fibers F2 having fiber diameters of 8 μm or more and 30 μm or less, which are mixed over the entire thickness of the nonwoven fabric. With this configuration, the output of the battery 10 is effectively increased by the operation described above.

(2) When manufacturing the nonwoven fabric S, the hot air A2 is further blown circumferentially about the hot air A1 so that the air curtain that blocks the outside air is formed. With this method, the fiber diameter of the nonwoven fabric S is effectively reduced.

### Second Embodiment

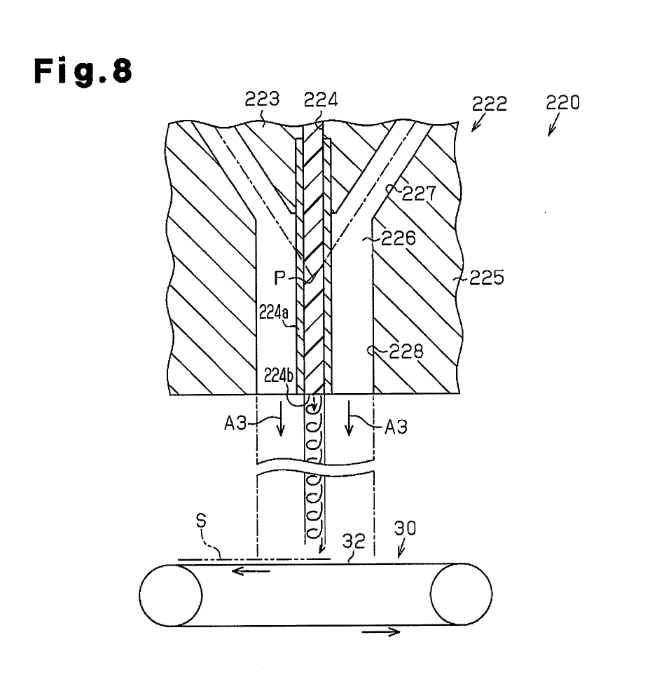

A second embodiment will now be described with reference to FIG. 8.

In the second embodiment, the structure of a manufacturing apparatus 220 for manufacturing the nonwoven fabric S differs from the afore-mentioned first embodiment. The differences will mainly be discussed below.

As shown in FIG. 8, a spinneret 222 of the manufacturing apparatus 220 includes a nozzle main body 223 and a cylindrical body 225 that surrounds the nozzle main body 223. A resin passage 224 is formed in the nozzle main body 223 to extend in the vertical direction.

The outer circumferential surface of the nozzle main body 223 is tapered downwardly, and a cylindrical nozzle pipe 224a, which discharges molten resin, is inserted in the distal end of the resin passage 224.

Part of the inner circumferential surface of the cylindrical body 225 that faces the outer circumferential surface of the nozzle main body 223 is tapered downwardly, and the outer circumferential surface and the inner circumferential surface define an inclined passage 227. Part of the inner circumferential surface of the cylindrical body 225 that faces the outer circumferential surface of the nozzle pipe 224a defines, together with the outer circumferential surface of the nozzle pipe 224a, a parallel passage 228, which extends downward in parallel with the central axis of the nozzle pipe 224a. The parallel passage 228 has an annular cross-section. The inclined passage 227 and the parallel passage 228 are arranged to be concentric with the nozzle pipe 224a.

The inclined passage 227 and the parallel passage 228 configure a passage 226 for blowing hot air A3 against molten resin discharged from the nozzle pipe 224a.

A distal end 224b of the nozzle pipe 224a is located downstream of, in the discharge direction of the molten resin, an intersection P of extended lines from streamlines of the hot air A3 flowing through the inclined passage 227, that is vertically downward of the intersection P.

Operation of the second embodiment will now be described.

Since the distal end 224b of the nozzle pipe 224a is located at the above-mentioned position, the flow of the hot air A3 is adjusted to become parallel with the discharge direction of the molten resin in the parallel passage 228 before the hot air A3 contacts the molten resin discharged from the nozzle pipe 224a. This prevents the discharged molten resin from being vibrated by the hot air A3, and the molten resin is extended in the discharge direction to thin down, so that the resin fiber is formed.

The second embodiment has the following advantage in addition to the advantage (1) of the first embodiment.

(3) The hot air A3 is blown out through the inclined passage 227, which is inclined to approach the nozzle pipe 224a toward the discharge direction of the molten resin, and the parallel passage 228, which extends downward from the distal end of the inclined passage 227 to be parallel with the central axis of the nozzle pipe 224a. Furthermore, the distal end of the nozzle pipe 224a is located downstream of, in the discharge direction of the molten resin, the intersection P of the extended line from the streamline of the hot air A3 flowing through the inclined passage 227. With this method, the fiber diameter of the nonwoven fabric S is effectively reduced.

The separator of the present invention is not limited to the configuration of the above-described embodiments, and can be adapted by being suitably modified as follows.

The percentages of the total sum of the cross-sectional area of the fine fibers and the total sum of the cross-sectional area of the thick fibers in the separators are preferably within ranges of 4% to 95% and 40% to 5%, respectively.

The nonwoven fabric S may be configured only with the fine fibers F1 and the thick fibers F2. That is, the intermediate fibers may be omitted.

The raw material of the nonwoven fabric may be changed to, for example, a thermoplastic resin other than polypropylene such as polyester and polyamide.

The thickness of the separators 12 is preferably within a range of 15 μm or more and 200 μm or less.

The porosity of the nonwoven fabric is preferably within a range of 40% or more and 70% or less.

The separator of the present invention may be employed as a separator for other electrochemical devices such as capacitors.

Therefore, the present examples and embodiments are to be considered as illustrative and not restrictive and the invention is not to be limited to the details given herein, but may be modified within the scope and equivalence of the appended claims.

1. A separator arranged between a pair of electrode sheets, the separator comprising: a nonwoven fabric formed of thermoplastic resin fibers spun by a melt-blowing process, wherein the fibers include fine fibers having fiber diameters of 0.1 μm or more and 1 μm or less and thick fibers having fiber diameters of 8 μm or more and 30 μm or less, and the fine fibers and the thick fibers are mixed over the entire thickness of the nonwoven fabric.

2. The separator according to claim 1, wherein the mean fiber diameter of the fine fibers is 0.8 μm.

3. The separator according to claim 1, wherein the average percentages of the number of the fine fibers and the number of the thick fibers are approximately 90% and approximately 10%, respectively.

4. The separator according to claim 1, wherein the fine fibers and the thick fibers are made of one of polypropylene, polyester, and polyamide.

5. A method for manufacturing the separator according to claim 1, comprising:
(a) discharging molten resin from a nozzle in a fibrous form;
(b) extending the fibrous molten resin by blowing hot air diagonally with respect to a discharge direction and from around onto the discharged fibrous molten resin, thereby forming extended resin fibers; and
(c) manufacturing a nonwoven fabric by collecting the extended resin fibers,
wherein, in the process (b), hot air forming an air curtain that blocks outside air is further blown circumferentially about the hot air blown onto the fibrous molten resin.

6. A method for manufacturing the separator according to claim 1, comprising:
(a) discharging molten resin from a nozzle in a fibrous form;
(b) extending the fibrous molten resin by blowing hot air from around onto the discharged fibrous molten resin, thereby forming extended resin fibers; and
(c) manufacturing a nonwoven fabric by collecting the extended resin fibers,
wherein, in the process (b), the hot air is discharged through an inclined passage, which is formed to surround the nozzle such that the inclined passage approaches the nozzle toward a discharge direction of the molten resin, and a parallel passage, which extends from a distal end of the inclined passage downward to be parallel with a central axis of the nozzle, and wherein the distal end of the nozzle is located downstream of, in the discharge direction of the molten resin, an intersection of lines extended from streamlines of the hot air flowing through the inclined passage.
